(19) United States
(12) Patent Application Publication
(10) Pub. No.: US 2023/0041163 A1
(43) Pub. Date: Feb. 9, 2023

(54) SPARSE MATRIX OPERATIONS FOR DEEP LEARNING

(71) Applicant: Google LLC, Mountain View, CA (US)

(72) Inventors: Erich Konrad Elsen, Naperville, IL (US); Trevor John Gale, San Francisco, CA (US); Reginald Clifford Young, Palo Alto, CA (US)

(21) Appl. No.: 17/791,771

(22) PCT Filed: Jan. 15, 2021
(86) PCT No.: PCT/US2021/013746

§ 371 Date: Jul. 8, 2022

Related U.S. Application Data
(60) Provisional application No. 62/961,645, filed on Jan. 15, 2020.

(51) Int. Cl. G06N 3/04; G06F 9/38

(52) U.S. Cl. CPC G06N 3/0481; G06F 9/3885

(57) ABSTRACT

Methods, systems, and apparatus, including computer programs encoded on computer storage media, for parallelizing matrix operations. One of the methods includes implementing a neural network on a parallel processing device, the neural network comprising at least one sparse neural network layer, the sparse neural network layer being configured to receive an input matrix and perform matrix multiplication between the input matrix and a sparse weight matrix to generate an output matrix, the method comprising: for each row of the M rows of the output matrix, determining a plurality of tiles that each include one or more elements from the row; assigning, for each tile of each row, the tile to a respective one of a plurality of thread blocks of the parallel processing device; and computing, for each tile, respective values for each element in the tile using the respective thread block to which the tile was assigned.

### CROSS-REFERENCE TO RELATED APPLICATION

This application claims priority to U.S. Provisional Application No. 62/961,645, filed Jan. 15, 2020, the entirety of which is herein incorporated by reference.

### BACKGROUND

This specification relates to neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that executes matrix operations using sparse matrices. A sparse matrix is a matrix that has a large proportion of elements that have a “null” value, i.e., values that are zero. A matrix can be considered sparse if more than a specified threshold proportion, e.g., 10%, 25%, 50%, or 75%, of the values of the matrix are null.

The system described in this specification can use a parallel processing device to execute multiple computations of the desired matrix operation in parallel. The parallel processing device can be, for example, a graphics processing unit (GPU), a tensor processing unit (TPU), an Edge TPU, a multicore CPU, a vision processing unit (VPU), or any other appropriate processing device that can execute multiple operations in parallel.

While the below description describes that threads of a parallel processing device can be organized into “thread blocks,” “warps,” and “subwarps,” generally the threads of a parallel processing device can be organized using any appropriate hierarchy and naming scheme.

Particular embodiments of the subject matter described in this specification can be implemented so as to realize one or more of the following advantages.

Performing matrix operations on sparse matrices can be more efficient and require fewer resources than performing the same matrix operations on similar dense matrices, e.g., dense matrices that have the same dimensions as the sparse matrices. In many cases, a dense matrix that is part of a deep neural network can be made sparse with little to no loss in the quality of the deep neural network; that is, the dense matrix can be processed (e.g., during training of the neural network or after the neural network has been trained) to generate a sparse matrix that is used in place of the dense matrix in the deep neural network. Converting dense weight matrices to sparse weight matrices makes the deep neural network more efficient both in terms of the number of floating-point operations required and in terms of the number of parameters that must be maintained in order to achieve a given predictive accuracy. Using the techniques described in this specification, the matrix operations performed by a deep neural network that has sparse weight matrices can be executed more efficiently using a parallel processing device. For example, performing inference using the neural network can be executed more quickly because the forward-pass matrix multiplications can be efficiently parallelized. As another example, training the neural network can be executed more quickly because the backpropagation matrix multiplications can be efficiently parallelized.

Some techniques described in this specification do not require any particular structure of the topology of the non-zero values in the sparse matrices. That is, such techniques can be performed on any sparse matrix, regardless of the placement or symmetry of the non-zero values in the sparse matrix.

Mapping tiles of the output matrix to thread blocks, as opposed to mapping entire rows of the output matrix to thread blocks, can allow the parallel processing device to be more nimble in balancing computations across streaming multiprocessors. The number of columns in the output matrix can vary drastically across different deep learning applications. In some cases where the output matrix has relatively many columns, it can be inefficient to assign an entire row of the output matrix to a single thread block compared to breaking up the computations of the row across multiple thread blocks and executing them in parallel. This allows the parallel processing device to achieve higher occupancy and a higher fraction of peak throughput. The size of the tiles can further be adjusted to customize the operations of the parallel processing device to a particular use case.

In some cases, sparse matrices that are used in deep neural networks have systematically different characteristics than sparse matrices that are used in other fields, e.g., in scientific computing fields.

As a particular example, sparse matrices used in deep learning contexts often have lower sparsity levels than sparse matrices used in other contexts; that is, sparse matrices in deep neural networks often have a lower fraction of null values. Lower sparsity levels can increase the likelihood that non-zero values in different rows of the sparse matrix fall into the same column in the sparse matrix. Using some techniques described in this specification, a parallel processing device can leverage the non-zero values that are in the same column of a sparse matrix to reuse operands in caches of the parallel processing device, further increasing the efficiency of the parallel processing device.

As another particular example, sparse matrices used in deep learning contexts often have longer average row lengths (i.e., the average number of nonzero values per row) than sparse matrices used in other contexts; that is, sparse matrices in deep neural networks often have more non-zero values per row. The average row length of a sparse matrix can capture the average amount of work that will be done on each row of the sparse matrix in order to execute the matrix operation. Using some techniques described in this specification, a parallel processing device can leverage the longer average row length of a sparse matrix to amortize startup overhead and one-time costs across more useful work. That is, the longer average row length causes the parallel processing device to do more work to generate the values for the output matrix, while the startup work remains the same, thus increasing the proportion of work that is “useful” and further increasing the average efficiency of the parallel processing device.

As another particular example, sparse matrices used in deep learning contexts often have a lower row-length coefficient of variation than sparse matrices used in other contexts. The coefficient of variation of a matrix's row length is the standard deviation of each row's length divided by the average row length of the matrix. A lower row-length coefficient of variation can indicate that the non-zero values of the matrix are more balanced across different rows of the matrix. Using some techniques described in this specification, a parallel processing device can leverage the load balance across the rows of a sparse matrix to assign computations more evenly across different nodes of the parallel processing device, e.g., across different streaming multiprocessors. That is, each streaming multiprocessor of the parallel processing device can be assigned approximately the same amount of computations, further increasing the efficiency of the parallel processing device.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B are block diagrams of example parallel processing devices.

FIGS. 2A and 2B are diagrams of example techniques for distributing computations of a matrix multiplication across nodes of a computing system.

FIGS. 3A-3C are diagrams of example techniques for increasing the efficiency of matrix operations.

FIG. 4 is a flowchart of an example process for parallelizing computations of a matrix multiplication.

Like reference numbers and designations in the various drawings indicate like elements.

### DETAILED DESCRIPTION

This specification describes a system that parallelizes the computations of a matrix operation that involves one or more sparse matrices.

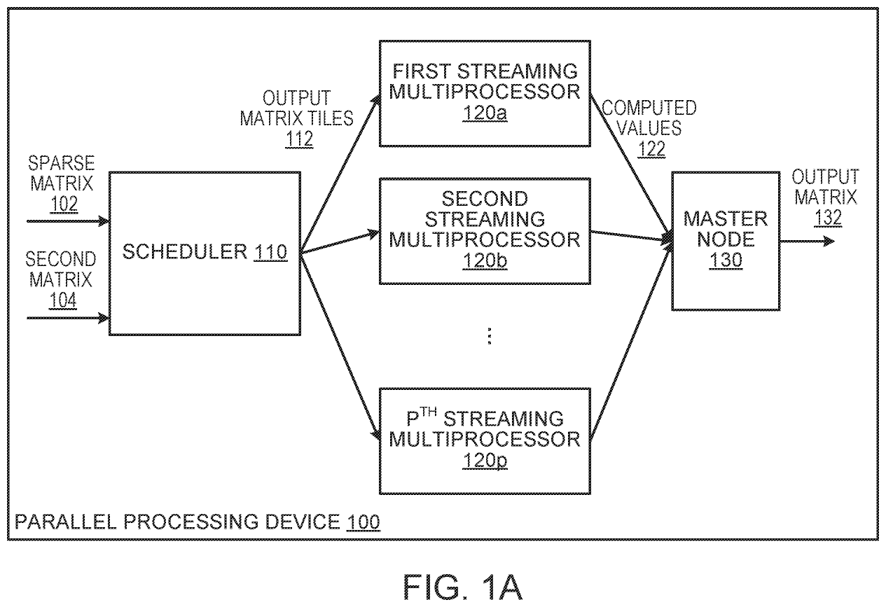

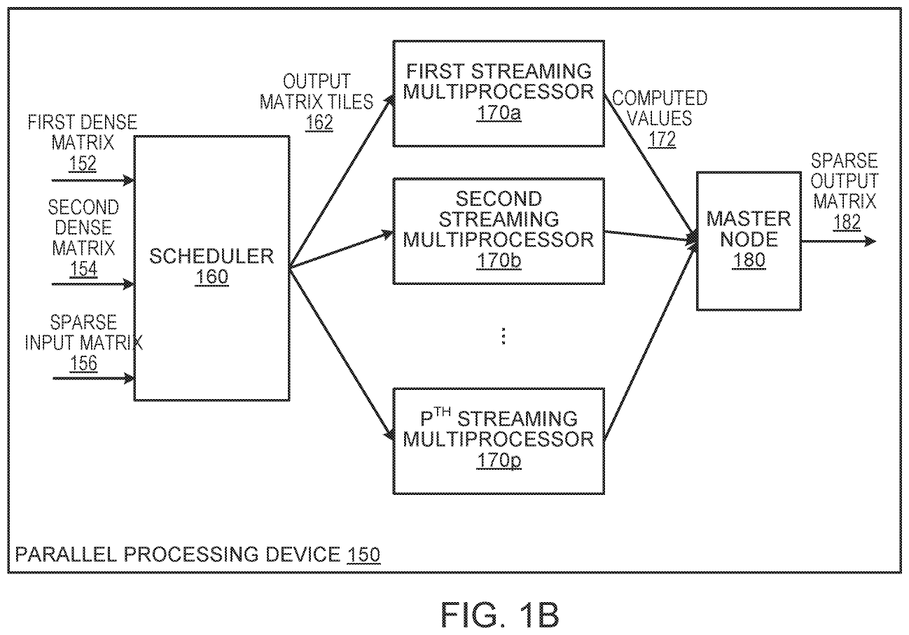

FIGS. 1A and 1B are block diagrams of example parallel processing devices. The parallel processing device 100 depicted in FIG. 1A is configured to perform a matrix multiplication between a sparse matrix and a second matrix to generate an output matrix. The parallel processing device 150 depicted in FIG. 1B is configured to perform a sampled dense-dense matrix multiplication, where two dense matrices are multiplied together and the elements of the product are sampled according to a sparse matrix (e.g., by performing an element-wise product between the product and the sparse matrix) to generate a sparse output matrix.

Referring to FIG. 1A, the parallel processing device 100 includes a scheduler 110, P streaming multiprocessors 120a-p, and (optionally) a master node 130. The parallel processing device 100 is configured to obtain a sparse matrix 102 and a second matrix 104, and to multiply the two matrices 102 and 104 to generate an output matrix 132. The second matrix 104 can be a dense matrix, or another sparse matrix. That is, the parallel processing device 100 is configured to compute A·B=C, where one or more of the matrices A or B are sparse.

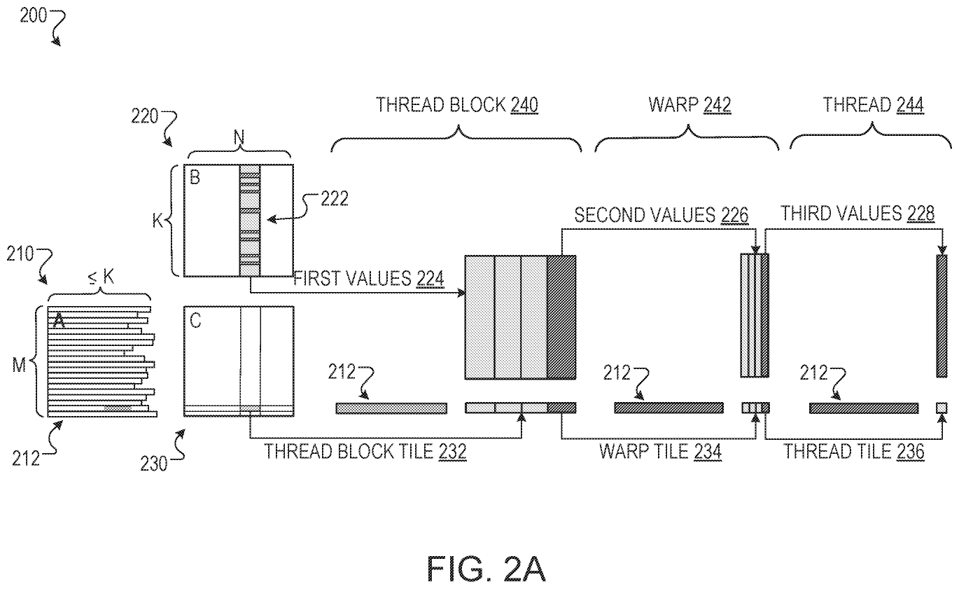

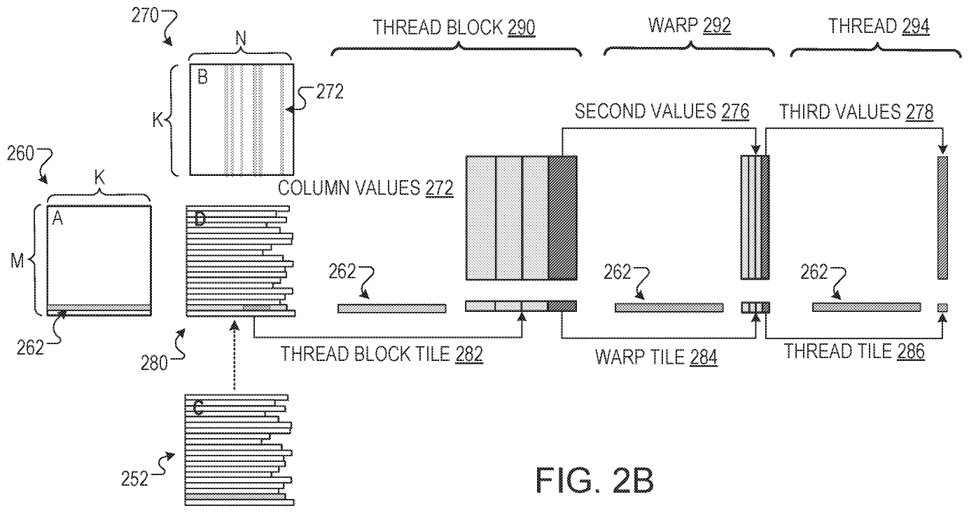

The scheduler 110 is configured to distribute the workload of executing the matrix multiplication across the P streaming multiprocessors 120a-p. In particular, the scheduler 110 shards the output matrix 132 into multiple one-dimensional tiles 112 that each include consecutive elements in a row of the output matrix 132. That is, for each row of the output matrix 132, the scheduler 110 groups the elements of the row into multiple tiles 112 of consecutive elements, where each element of the row is assigned to exactly one tile 112. This process is described in more detail below with reference to FIG. 2A.

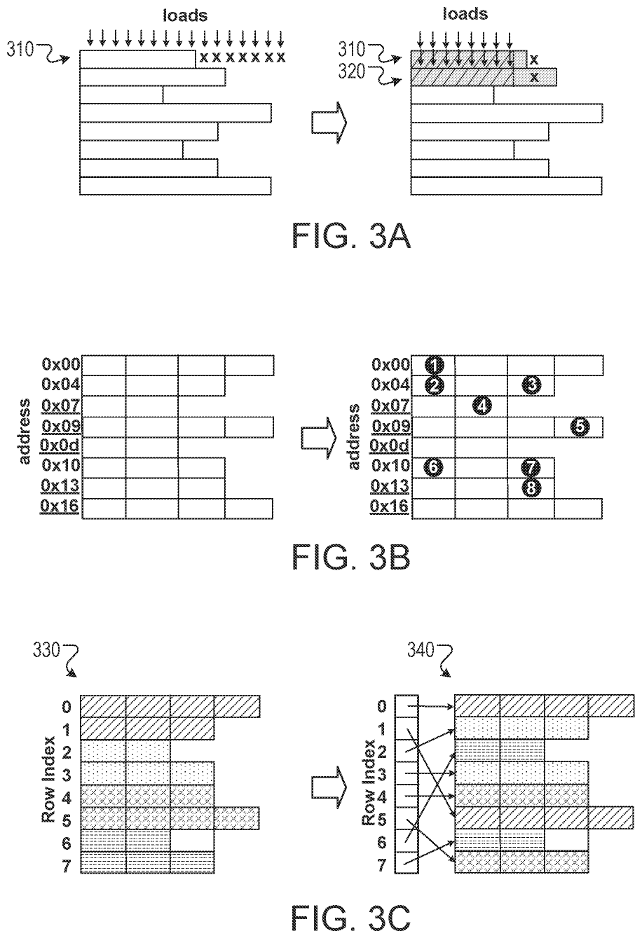

After determining the tiles 112 of the output matrix 132, the scheduler 110 assigns each tile to a respective streaming multiprocessor 120a-p. In some implementations, the scheduler 110 assigns each tile 112 to a respective streaming multiprocessor 120a-p before execution of the streaming multiprocessors 120a-p. In some other implementations, the scheduler 110 assigns a batch of one or more tiles 112 to each streaming multiprocessor 120a-p before execution while keeping some tiles 112 unassigned. Then, as the streaming multiprocessors 120a-p complete the computations related to the tiles 112 assigned to them, the scheduler 110 assigns the remaining tiles 112 to respective streaming multiprocessors 120a-p, e.g., in response to a notification from a particular streaming multiprocessor that the particular streaming multiprocessor has completed the work already assigned to it. An example distribution process is discussed in more detail below with reference to FIG. 3C.

Each streaming multiprocessor 120a-p is configured to compute a respective value for each element of each tile 112 that has been assigned to the streaming multiprocessor by the scheduler 110. Typically, each streaming processor 120a-p distributes these computations across one or more thread blocks of the streaming processor. Each thread block can include one or more warps, which each include one or more threads that are configured to execute the computations of the matrix multiplication. This process is discussed in more detail below with reference to FIG. 2A.

Although a set of streaming multiprocessors of the same parallel processing device is depicted in FIG. 1A, generally the computations of a matrix operation can be distributed across multiple different parallel processing devices, e.g., across a distributed computing system of multiple computers in one or more locations. Furthermore, although streaming multiprocessors are depicted in FIG. 1A, generally the parallel processing device 100 (or the system of parallel processing devices) can contain nodes of any type that are configured to execute the computations of a matrix operation.

In some implementations, after each streaming multiprocessor 120a-p computes respective values 122 for each tile 112 assigned to it, the streaming multiprocessor can provide the computed values 122 to the master node 130. The master node 130 can be configured to collect the computed values 122 for each tile 112 of the output matrix 132, and compile the values together to generate the final output matrix 132. The master node 130 can be one of the streaming processors 120a-p, or the master node 130 can be a separate component from the streaming processors 120a-p.

In some other implementations, the streaming multiprocessors 120a-p do not provide the computed values 122 to a master node 130; rather, each streaming multiprocessor 120a-p can store its respective computed values 122 in a location in the memory of the parallel processing device that can be accessed by each streaming multiprocessor 120a-p. That is, the streaming multiprocessors compile the computed values into the output matrix 132 themselves by placing their respective computed values 122 in appropriate locations in memory. The output matrix 132 can then be accessed from the memory of the parallel processing device 100 by a downstream component for further processing. For example, the parallel processing device 100 can use the output matrix 132 to execute another matrix operation, e.g., another matrix multiplication. As another example, an external system to the parallel processing device 100 can request the output matrix 132 for further processing.

In some implementations, the scheduler 110 is not on the parallel processing device 100, i.e., scheduler 110 can be hosted on one or more different devices than the streaming multiprocessors 120a-p. As a particular example, the scheduler 110 can be local to a user device that submits a request to perform the matrix multiplication, while the parallel processing device 100, which hosts the streaming multiprocessors 120a-p, can be on the cloud.

In other words, the scheduler 110 can cause the parallel processing device 100 to parallelize the matrix multiplication. In some implementations, the operations of the scheduler 110 are performed on the parallel processing device 100, and the causing includes executing the operations on the parallel processing device 100. In some other implementations, the operations of the scheduler 110 are performed on one or more different devices than the parallel processing device 100, and the causing includes providing instructions for the parallelization to the parallel processing device 100, e.g., over a communication link that is established between the scheduler 110 and the parallel processing device 100.

In some implementations, the parallel processing device 100 is a component of an inference system for a neural network.

For example, the neural network can include one or more neural network layers that have sparse weight matrices. When the inference system receives a new input to the neural network, the inference system can execute the operations of each neural network layer that has a sparse weight matrix using the parallel processing device 100. That is, the inference system can use the parallel processing device 100 to compute W·X=Y, where W is the sparse weight matrix for the neural network layer, X is the input activation matrix, and Y is the output activation matrix. In particular, the inference system can provide, to the parallel processing device, i) the sparse weight matrix for the neural network layer as the sparse matrix 102 and ii) the dense input activation matrix generated by the previous neural network layer in the neural network as the second matrix 104. The parallel processing device 100 can then generate the output activation matrix for the neural network layer as the output matrix 132, as described above. The inference system can execute the operations of each neural network layer that has a dense weight matrix using standard matrix multiplication, e.g., using the parallel processing device 100 or another processing device.

As another example, the neural network can include one or more neural network layers that accept sparse input activation matrices. When the inference system receives a new input to the neural network, the inference system can execute the operations of each neural network layer that accepts sparse input activation matrices using the parallel processing device 100. That is, the inference system can use the parallel processing device 100 to compute W·X=Y, where W is the weight matrix for the neural network layer (i.e., the second matrix 104), X is the sparse input activation matrix (i.e., the sparse matrix 102), and Y is the output activation matrix (i.e., the output matrix 132).

As another example, the neural network can include one or more neural network layers that both i) have a sparse weight matrix and ii) accept sparse input activation matrices. That is, the inference system can use the parallel processing device 100 to compute W X=Y, where W is the sparse weight matrix for the neural network layer, X is the sparse input activation matrix, and Y is the output activation matrix.

In some other implementations, the parallel processing device 100 is a component of a training system for a neural network.

For example, when the training system receives a new training input to the neural network, the training system can execute a forward pass of the neural network by processing the new training input similarly to the inference system described above.

As another example, having generated a training network output for a training network input, the training system can execute a backward pass of the neural network to update the parameter values of the neural network using backpropagation.

As a particular example, the training system can use the parallel processing device 100 to compute W^{T}·δY=δX, where W is a sparse weight matrix for a neural network layer, δY is the gradient of the output activation matrix for the neural network layer, and δX is the gradient of the input activation matrix for the neural network layer. In particular, the training system can provide, to the parallel processing device 100, i) the transpose of the current sparse weight matrix as the sparse matrix 102 and ii) the backpropagated gradient matrix from the subsequent neural network layer in the neural network as the second matrix 104. The parallel processing device 100 can execute the matrix multiplication to generate the gradient matrix for the input to the neural network layer and use it to continue the backpropagation. As another particular example, the gradient δY of the output activation matrix can be sparse (i.e., the sparse matrix 102) and the weight matrix W can be dense (i.e., the second matrix 104). As another particular example, both the weight matrix W and the gradient δY of the output activation matrix can be sparse.

Referring to FIG. 1B, the parallel processing device 150 includes a scheduler 160, P streaming multiprocessors 170a-p, and (optionally) a master node 180. The parallel processing device 150 is configured to obtain two dense matrixes 152 and 154 and a sparse input matrix 156, and to perform a sampled dense-dense matrix multiplication to generate a sparse output matrix 182.

That is, the parallel processing device 150 is configured to compute [A·B]⊙C=D, where the matrices A and B are dense (i.e., the dense matrices 152 and 154), the matrix C is sparse (i.e., the sparse input matrix 156), the matrix D is sparse (i.e., the sparse output matrix 182), and ⊙ is the element-wise product of two matrices.

The scheduler 160 is configured to distribute the workload of executing the sampled dense-dense matrix multiplication across the P streaming multiprocessors 170a-p. In particular, the scheduler 110 shards the sparse output matrix 182 into multiple one-dimensional tiles 162 that each include consecutive non-zero elements in a row of the sparse output matrix 162. Because the non-zero elements in the sparse output matrix 182 are in the same locations as the non-zero elements in the sparse matrix 156 (due to the element-wise product), the scheduler 160 can determine, for each row of the sparse output matrix 182, which elements may be non-zero, and group the non-zero elements of the row into multiple tiles 162 of consecutive non-zero elements, where each non-zero element of the row is assigned to exactly one tile 162. This process is described in more detail below with reference to FIG. 2B.

After determining the tiles 162 of the sparse output matrix 182, the scheduler 160 assigns each tile to a respective streaming multiprocessor 170a-p, as described above with reference to FIG. 1A. Each streaming multiprocessor 170a-p is configured to compute a respective value for each element of each tile 162 that has been assigned to the streaming multiprocessor by the scheduler 160. This process is discussed in more detail below with reference to FIG. 2B.

Although a set of streaming multiprocessors of the same parallel processing device is depicted in FIG. 1B, generally the computations of a matrix operation can be distributed across multiple different parallel processing devices. Furthermore, although streaming multiprocessors are depicted in FIG. 1B, generally the parallel processing device 150 (or the system of parallel processing devices) can contain nodes of any type that are configured to execute the computations of a matrix operation.

In some implementations, after each streaming multiprocessor 170a-p computes respective values 172 for each tile 162 assigned to it, the streaming multiprocessor can provide the computed values 172 to the master node 180. The master node 180 can be configured to collect the computed values 172 for each tile 162 of the sparse output matrix 182, and compile the values together to generate the final sparse output matrix 182. The master node 180 can be one of the streaming processors 170a-p, or the master node 180 can be a separate component from the streaming processors 170a-p.

In some other implementations, the streaming multiprocessors 170a-p do not provide the computed values 172 to a master node 180; rather, the streaming multiprocessors compile the computed values into the sparse output matrix 182 themselves by placing their respective computed values 172 in a location in the memory of the parallel processing device 150 that can be accessed by each streaming multiprocessor 170a-p. The output matrix 182 can then be accessed from the memory of the parallel processing device 150 by a downstream component for further processing.

In some implementations, the scheduler 160 is not on the parallel processing device 150. As a particular example, the scheduler 160 can be local to a user device that submits a request to perform the sampled dense-dense matrix multiplication, while the parallel processing device 150, which hosts the streaming multiprocessors 170a-p, can be on the cloud.

In some implementations, the parallel processing device 150 is a component of a training system for a neural network.

For example, when the training system receives a new training input to the neural network, the training system can execute a forward pass of the neural network by processing the new training input to generate a training output. Having generated the training network output, the training system can execute a backward pass of the neural network using the parallel processing device 150 to update the parameter values of the neural network using backpropagation.

As a particular example, the neural network can include one or more neural network layers that have sparse weight matrices. During the backpropagation, the training system can use the parallel processing device 100 to compute [δY·X^{T}]⊙Π(W)=δW, where W is the sparse weight matrix for a neural network layer, δY is the gradient of the output activation matrix for the neural network layer, X is the input activation matrix for the neural network layer, Π is the indicator function that returns 1 for nonzero elements of W, and δW is the gradient of the weight matrix. In particular, the training system can provide, to the parallel processing device 150, i) the transpose of the input activation matrix and the gradient of the output activation matrix (backpropagated from the subsequent neural network layer in the neural network) as the dense matrices 152 and 154, and ii) either the weight matrix W itself or the matrix Π(W) that identifies the non-zero elements of the weight matrix Was the sparse input matrix 156. The parallel processing device 150 can execute the sampled dense-dense matrix multiplication to generate the gradient of the weight matrix (as the sparse output matrix 182) and use it to update the values of the weight matrix.

As another particular example, the neural network can include one or more neural network layers that accept sparse input activation matrices. During the backpropagation, the training system can use the parallel processing device 150 to compute [W^{T}·δY]└Π(X)=δX, where X is the sparse input activation matrix for a neural network layer, W is the weight matrix for the neural network layer, δY is the gradient of the output activation matrix for the neural network layer, and δX is the gradient of the input activation matrix. In particular, the training system can provide, to the parallel processing device 150, i) the transpose of the weight matrix and the gradient of the output activation matrix (backpropagated from the subsequent neural network layer in the neural network) as the dense matrices 152 and 154, and ii) either the input activation matrix X itself or the matrix Π(X) that identifies the non-zero elements of the input activation matrix X as the sparse input matrix 156. The parallel processing device 150 can execute the sampled dense-dense matrix multiplication to generate the gradient of the input activation matrix (as the sparse output matrix 182) and use it to continue the backpropagation through the preceding neural network layers in the neural network.

FIGS. 2A and 2B are diagrams of example techniques for distributing computations of a matrix multiplication across nodes of a computing system.

The technique 200 depicted in FIG. 2A distributes computations for a matrix multiplication between a sparse matrix and a second matrix to generate an output matrix. The technique 250 depicted in FIG. 2B distributes computations for a sampled dense-dense matrix multiplication to generate a sparse output matrix.

Referring to FIG. 2A, the computing system is configured to receive a sparse matrix 210 of size M×K and a second matrix 220 of size K×N, and to perform matrix multiplication between the two matrices 210 and 220 to generate an output matrix 230 of size M×N. The computing system can include one or more parallel processing devices, e.g., the parallel processing device 100 depicted in FIG. 1A.

In some implementations, the sparse matrix is received in compressed sparse row (CSR) format. In some other implementations, the sparse matrix is received in doubly compressed sparse row (DCSR) format. The second matrix can be a dense matrix or a sparse matrix.

For each row of the M rows of the output matrix 230, the computing system can decompose the row into multiple tiles, where each tile is a one-dimensional sequence of consecutive elements of the row of the output matrix. Every element in the output matrix can be assigned to exactly one tile. In some implementations, each of the tiles have the same size T; that is, there are T elements per tile. Thus, for each row of the output matrix 230, the 0^{th} through (T−1)th elements represent one tile, the T^{th} through (2T−1)^{th} elements represent another tile, and so on. For example, the computing system or a user can select a tile size T such that Nis divisible by T, i.e., there are N/T tiles per row, and a total of K·N/T tiles in the output matrix. In some cases, N may not be divisible by T; in these cases, each tile in the output matrix that is not the final tile in a row can have size T, while the final tile in each row can have size N mod T, where “mod” is the modulo operator that returns the remainder when Nis divided by T.

The computing system can assign each tile in the output matrix 230 to a particular thread block of a parallel processing device—thus, the tiles are sometimes called “thread block tiles.” The thread block of the parallel computing device then computes the values of the elements in the assigned tile by executing the matrix multiplication. After values for every tile have been computed by respective thread blocks, the computing system can combine the tiles to generate a complete output matrix 230 that includes a computed value for every element, as described above with reference to FIG. 1A.

A thread block represents a group of threads that can be executed either in series or in parallel. A thread block can include one or more warps. A warp is sub-grouping of the threads of the thread block that can execute the same operations on all of the threads in parallel. That is, the warp can process a single instruction across all of the threads of the warp at the same time. Thus, generating the value for a single element in the tile can be assigned to a particular thread; a warp can compute the values of multiple elements across respective threads in parallel; and the thread block for the tile can execute the operations of each of the warps of the thread block either in series or in parallel.

A thread is a sequence of operations that can be executed independently by a processing unit of the parallel processing device. As a particular example, each thread block can be assigned to execute on a particular streaming multiprocessor of the parallel processing device. For example, a GPU can have, e.g., 12, 16, or 20 streaming processors. Each streaming multiprocessor can execute one or more threads of a respective assigned thread block in parallel. Each thread running of a streaming multiprocessor can share the resources of the streaming multiprocessor, e.g. the computing units, shared memory, constant cache, L1 cache, etc. of the streaming multiprocessor.

In order to compute the values for the elements in a particular tile, the computing system can isolate the values in the sparse matrix and the second matrix that will be processed to compute the values. In particular, the value for element (r, i) of the output matrix is computed by multiplying the i^{th} column of the second matrix with row r of the sparse matrix. However, since many of the values of row r of the sparse matrix are null, the computing system can increase efficiency by only retrieving those values in the i^{th} column of the second matrix that will be multiplied by a non-zero element of row r of the sparse matrix.

As a specific example, a particular thread block tile 232 of the output matrix 230, which corresponds to a row 212 of the sparse matrix 210 and a set of multiple columns 222 of the second matrix, is depicted in FIG. 2A. The computing system assigns the thread block tile 232 to the thread block 240.

The thread block 240 can obtain i) the values of the row 212 of the sparse matrix 210 and ii) the first values 224 of the set of columns 222 of the second matrix 220, which are the values of the set of columns 222 that correspond to the values of the row 212 of the sparse matrix 210. That is, because the columns 222 will be multiplied by the row 212 that is sparse, the thread block 240 only needs to obtain the values 224 of the columns 222 that will be multiplied by the non-zero values of the row 212. These first values 224 of the columns 222 are represented by a darker shade of gray than the other values of the columns 222. Note that the shaded values are sparse and distributed across the rows of the columns 222—these rows correspond to the non-zero elements in the row 212.

The thread block 240 can place the obtained values in a cache that is accessible by each warp and thread in the thread block 240. In some implementations, the thread block 240 obtains every value in the columns 222 and discards the values that correspond to zero elements of the row 212 (i.e., discards the values that are not the first values 224). In some other implementations, the thread block 240 only obtains the first values 224.

In some implementations, multiple warps of the thread block 240 collaboratively load and store some or all of the required values values (e.g., the values of the row 212 and/or the first values 224) in a shared memory of the thread block 240, such that each thread of the thread block can access the values.

The thread block 240 can distribute the computation of the values for the thread block tile 232 across multiple different warps. For example, the thread block 240 can assign a warp 242 to compute the values for a warp tile 234. The warp tile 234 is a subset of the thread block tile 232, i.e., includes multiple consecutive elements from the thread block tile 232. To compute the values for the elements in the warp tile 234, the warp 242 can obtain second values 226 of the second matrix 220. The second values 226 are a subset of the first values 224 that correspond to the warp tile 234. In particular, the second values 226 are the first values 224 that are in the columns represented in the warp tile 234 (which are a subset of the columns 222).

The warp 242 can in turn distribute the computation of the values for the warp tile 234 across multiple different threads. For example, the warp 242 can assign a respective thread to compute each element in the warp tile 234 in parallel. As a particular example, the warp 242 can assign a thread 244 to compute the value for a thread tile 236, which can include a single element from the warp tile 234. To compute the value for the element in the thread tile 236, the thread 244 can obtain third values 228 of the second matrix 220. The third values 228 are a subset of the second values 226 that correspond to the thread tile. In particular, the third values 228 are the second values 226 that are in the column represented in the thread tile 236.

For example, to compute the value for the thread tile 236, the thread 244 can partition the row 212 into multiple sub-tiles, where each sub-tile of the row 212 includes one or more consecutive non-zero elements of the row 212. For each sub-tile of the row 212, the thread 244 can determine the corresponding third values in the set of third values 228, i.e., the third values with which the elements of the sub-tile of the row 212 are to be multiplied to compute the value for the thread tile 236 during the inner product computation. The thread 244 can combine, for each sub-tile of the row 212, i) the values of the sub-tile and ii) the corresponding third values in the set of third values 228 using an inner product to generate a scalar value. The thread 244 can then determine the sum of the scalar values corresponding to each sub-tile of the row 212 to generate the value for the thread tile 236.

Although the thread block 240 is depicted as having 4 warps and the warp 242 is depicted as having 4 threads, in general a thread block can have many more warps and a warp can have many more threads. To name a few examples, a thread block can include 512 or 1024 threads total, and a warp can include 32 or 64 threads.

Although FIG. 2A depicts a matrix multiplication A B where A is sparse, the techniques described in this specification can be used to compute a matrix multiplication A B where B is sparse. For example, a sparse matrix B can be represented in a sparse column format, e.g., compressed sparse column (CSC) format or doubly compressed sparse column (DCSC) format. That is, the sparse matrix can be the “right” matrix in the matrix multiplication, while the second matrix can be the “left” matrix in the matrix multiplication. In these implementations, instead of obtaining a row of the sparse matrix 210 and columns of the second matrix 220 as described above, the system can obtain rows of the second matrix (which is on the left in these implementations) and a column of the sparse matrix (which is on the right in these implementations). The operations of computing elements of the output matrix can then be distributed across thread blocks, warps, and threads as described above.

Referring to FIG. 2B, the computing system is configured to receive a first dense matrix 260 of size M×K, a second dense matrix 270 of size K×N, and a sparse input matrix 252 of size M×N. The computing system is configured to execute a sampled dense-dense matrix multiplication using the two dense matrices 260 and 270 and the sparse input matrix 252 to generate a sparse output matrix 280 of size M×N. The computing system can include one or more parallel processing devices, e.g., the parallel processing device 150 depicted in FIG. 1B.

For each row of the M rows of the sparse output matrix 280, the computing system can decompose the row into multiple tiles, where each tile is a one-dimensional sequence of consecutive non-zero elements of the row of the sparse output matrix 280. The system can determine the non-zero elements of the sparse output matrix 280 using the sparse input matrix 252; namely, for each non-zero element in the sparse input matrix 252, the corresponding element (i.e., the element in the same row and same column) of the sparse output matrix 280 may be non-zero.

Note that it is possible that the element (i, j) in the sparse output matrix 280 corresponding to a non-zero element (i, j) in the sparse input matrix 252 is equal to zero, if the inner product between row i of the first dense matrix 260 and the column j of the second dense matrix 270 is equal to zero. However, despite this possibility, the system can treat each element in the sparse output matrix 280 that corresponds to a non-zero element in the sparse input matrix 252 as a “non-zero” element of the sparse output matrix 280.

Every non-zero element in the sparse output matrix 280 can be assigned to exactly one tile. In some implementations, each of the tiles have the same size T. Generally, because of the sparsity of the output matrix, the number of non-zero elements in a given row will not be divisible by T. In these cases, each tile in the sparse output matrix 280 that is not the final tile in a row can have size T, while the final tile in each row can have size N mod T.

The computing system can assign each tile in the sparse output matrix 280 to a particular thread block of a parallel processing device—thus, the tiles are sometimes called “thread block tiles.” The thread block of the parallel computing device then computes the values of the elements in the assigned tile. After values for every tile have been computed by respective thread blocks, the computing system can combine the tiles to generate a complete sparse output matrix 280 that includes a computed value for every non-zero element of the sparse output matrix 252, as described above with reference to FIG. 1B.

In order to compute the values for the elements in a particular tile, the computing system can determine i) the corresponding row in the first sparse matrix 260 and ii) the multiple corresponding columns in the second sparse matrix 270. In particular, the value for element (r, i) of the output matrix is computed by multiplying the i^{th} column of the second dense matrix 270 with row r of the first dense matrix 260.

As a specific example, a particular thread block tile 282 of the output matrix 230, which corresponds to a row 262 of the first dense matrix 260 and a set of multiple columns 272 of the second dense matrix 270, is depicted in FIG. 2B. Note that the columns 272 are sparse—these columns correspond to the non-zero elements in the tile 282. The computing system assigns the thread block tile 282 to the thread block 290.

The thread block 290 can obtain i) the values of the row 262 of the first dense matrix 260 and ii) the values of the set of columns 272 of the second dense matrix 270. The thread block 290 can place the obtained values in a cache that is accessible by each warp and thread in the thread block 290. In some implementations, multiple warps of the thread block 290 collaboratively load and store some or all of the required values (e.g., the values of the row 262 and/or the column 272) in a shared memory of the thread block 290, such that each thread of the thread block can access the values.

The thread block 290 can distribute the computation of the values for the thread block tile 282 across multiple different warps. For example, the thread block 290 can assign a warp 292 to compute the values for a warp tile 284. The warp tile 284 is a subset of the thread block tile 282, i.e., includes multiple consecutive elements from the thread block tile 282. To compute the values for the elements in the warp tile 284, the warp 292 can obtain second values 276 of the second dense matrix 270. The second values 276 are the values of the subset of the columns 272 that correspond to the warp tile 234, i.e., the columns of the second dense matrix 270 represented in the warp tile 284 (which are a subset of the columns 272).

The warp 292 can in turn distribute the computation of the values for the warp tile 284 across multiple different threads. For example, the warp 292 can assign a respective thread to compute each element in the warp tile 284 in parallel. As a particular example, the warp 292 can assign a thread 294 to compute the value for a thread tile 286, which can include a single element from the warp tile 284. To compute the value for the element in the thread tile 286, the thread 294 can obtain third values 278 of the second dense matrix 220. The third values 228 are the values of the columns in the set of the columns 272 that corresponds to the thread tile, i.e., the column of the second dense matrix that corresponds to the element of the warp tile 284.

For example, to compute the value for the thread tile 286, the thread 294 can partition the row 262 into multiple sub-tiles, where each sub-tile of the row 262 includes one or more consecutive elements of the row 262. For each sub-tile of the row 262, the thread 294 can determine the corresponding third values in the set of third values 278, i.e., the third values with which the elements of the sub-tile of the row 262 are to be multiplied to compute the value for the thread tile 286 during the inner product computation. The thread 294 can combine, for each sub-tile of the row 262, i) the values of the sub-tile and ii) the corresponding third values in the set of third values 278 using an inner product to generate a scalar value. The thread 294 can then determine the sum of the scalar values corresponding to each sub-tile of the row 262 to generate the value for the thread tile 286.

In some implementations, the second dense matrix 270 is transpose of the matrix that is provided to the system; that is, if the system is provided matrix B, then the system computes [A·B^{T}]└C=D. For example, as described above with reference to FIG. 1B, the system can determine the gradient of a sparse weight matrix of a neural network by computing [δY·X^{T}]└Π(W)=δW, where X^{T} is the second dense matrix 270 but X is provided to the system.

In some such implementations, e.g., when the second dense matrix is stored in row-major format, assigning each element of the thread block tile 282 to a respective thread, as described above, results in each thread executing strided, uncoalesced memory accesses to the shared memory of the thread block 290, which is an inefficient use of time and computational resources. Therefore, the system can assign work to the threads of the thread block 290 such that each thread executes a portion of the computations required to determine the value for multiple elements (e.g., all elements) in the tile 282. That is, for each element of the tile 282, multiple different threads can collaborate to compute the value for the element. Then, the thread block 290 can execute a reduction across all the threads to compute the final value for the element, e.g., using warp shuffle instructions.

FIGS. 3A-3C are diagrams of example techniques for increasing the efficiency of executing matrix operations. For example, the techniques illustrated in FIGS. 3A-3C can be used to execute a matrix multiplication between a sparse matrix and a second matrix to generate an output matrix. Although the below description may refer to the sparse matrix being the “left” matrix in the matrix multiplication, the techniques described can be applied when the sparse matrix is the “right” matrix in the matrix multiplication, or when both matrices in the matrix multiplication are sparse.

For convenience, the techniques will be described as being performed by a system of one or more computers located in one or more locations. For example, a parallel processing device, e.g., the parallel processing device 100 depicted in FIG. 1A, appropriately programmed in accordance with this specification, can perform the techniques.

FIG. 3A illustrates an example technique for using vector memory instructions to load values of a sparse matrix to the memory of a parallel processing device.

Vector memory instructions allow a component of a parallel processing device (e.g., a thread block, a warp, or a subwarp of the parallel processing device) to load multiple blocks of data to memory at a time. That is, instead of obtaining and placing each block of data into memory at a time, the component can obtain multiple blocks of data simultaneously, with a single instruction.

For example, without vector memory instructions, the access width (i.e., the amount of data loaded with a single instruction) of the parallel processing device might be 32 floating point values. Using vector memory instructions with a vector width of two, each component of the parallel processing device can load twice as many values, e.g., 64 floating point values, with a single instruction. Similarly, using vector memory instructions with a vector width of four, each component of the parallel processing device can load four times as many values, e.g., 128 floating point values, with a single instruction. Thus, vector memory instructions can significantly improve the efficiency of the parallel processing device.

As a particular example example, if each warp in the parallel processing device includes 32 threads, then without vector memory instructions, each warp can load, with a single instruction, a single respective value for each thread in the warp to process. Using vector memory instructions with a vector width of two, each warp can load, with a single instructions, two respective values for each thread in the warp to process.

However, in some cases where only a single tile is assigned to each thread block, the number of values that the thread block must process is not enough to effectively use vector memory instructions. For example, when a thread block is loading values from the sparse matrix, the number of elements in the row of the sparse matrix corresponding to the tile that was assigned to the thread block is less than the number of values loaded using the vector memory instruction, thus causing the thread block to load extra values that will not be used when executing the matrix multiplication.

Therefore, the parallel processing device can be made more efficient by assigning multiple different tiles to each thread block; in particular, a scheduler (e.g., the scheduler 110 depicted in FIG. 1A) can assign tiles corresponding to respective different rows of the sparse matrix to a single thread block. For example, each warp of the thread block can be assigned a respective tile. As another example, each subwarp of the thread can be assigned a respective tile. A subwarp is a subset of the threads of a warp. For example, instead of assigning each tile of the output matrix to a respective thread block of the parallel processing device, the system can assign multiple tiles to the same thread block, which in turn assigns each tile to a respective subwarp.

In the example depicted in FIG. 3A, on the left side, a component of the parallel processing device uses a vector memory instruction with a vector width of two to load values of a single row 310 of the sparse matrix. The values loaded by the component are represented by arrows. For example, if a tile corresponding to the row 310 has been assigned to a warp, then the warp can execute the vector memory instruction. Because there are fewer values in the row 310 than are loaded by the vector memory instruction, the warp performs wasted operations by loading values that will not be used by the warp. The unused values are represented by X's.

Continuing the example depicted in FIG. 3A, on the right side, a component of the parallel processing device uses a vector memory instruction with a vector width of two to load values of two rows 310 and 320 of the sparse matrix. The values loaded by the component are again represented by arrows. For example, if respective tiles corresponding to the row 310 and the row 320 have been assigned to a warp (e.g., to respective subwarps of the warp), then the warp can execute the vector memory instruction. Because the vector memory instruction is directed to two different rows 310 and 320 of the sparse matrix, there are no wasted operations, i.e., all values loaded by the warp will be used by the warp. Thus, assigning multiple tiles to a single thread block or warp, increasing the number of values that the thread block or warp must process, can allow the thread block or warp to better leverage vector memory instructions.

As a particular example, a warp of a thread block can load the values of the rows 310 and 320 into a location in the shared memory of the thread block, where the values can be accessed by each thread of the thread block to compute values for elements of the output matrix. The remaining values of the rows 310 and 320 can be loaded, e.g., by the same warp or a different warp, using a subsequent vector memory instruction.

FIG. 3B illustrates an example technique for executing vector memory instructions on the parallel processing device.

Vector memory access can require that the target value of the instruction (i.e., the first address of the data requested by the instruction) be aligned to a particular vector width of the vector memory instructions of the parallel processing device (e.g., a vector width of two or four 32-byte values). That is, the first address in the requested data must be a multiple of the vector width, i.e., must be “vector-width-aligned.”

In some cases, e.g., in some cases where the sparse matrix is represented in CSR format, the first non-zero value in a row of the sparse matrix (called the “row offset” of the row) is not aligned with the vector width. This presents an issue when a component (e.g., a thread block or warp) of the parallel processing device submits a vector memory instruction to read the values of the row of the sparse matrix; namely, the first address of the vector memory instruction cannot be the address of the first non-zero value of the row.

To address this issue, when loading the values of a row of the sparse matrix, a component of the parallel processing device can load the row offset of the row and calculate the row length of the row, and then decrement the row offset to the nearest vector-width-aligned address to generate a decremented offset. The component can then submit a vector memory instruction whose target value is the decremented offset, causing the component to load values from the previous row of the sparse matrix (if the address of the row offset was not already vector-width-aligned). In order to maintain correctness, the component can determine not process the values from the previous row. For example, each of the threads of the component can mask the values that were loaded from the previous row.

Referring to the example depicted in FIG. 3B, the addresses of the first non-zero value of some of the rows of a sparse matrix are not vector-width-aligned. In particular, the addresses of the third, fourth, fifth, seventh, and eighth rows are not vector-width-aligned. Therefore, when requesting the values for one of those rows, a component of the parallel processing device can decrement the target value to the nearest vector-width-aligned address. For example, when requesting the values for the third row, the target value is an element of the second row, and therefore the request will return values of the last portion of the second row followed by the values of the third row. Similarly, a request for the fourth row will return values of the last portion of the third row followed by the values of the fourth row, and so on. In FIG. 3B, the target value of a request for the i^{th} row is represented by i^{th} circle.

FIG. 3C illustrates an example technique for load balancing the computations of the matrix multiplication across components of the parallel processing device.

While the below description refers to the system assigning tiles to thread blocks of a parallel processing device, the techniques described can be applied to any appropriate component of a parallel processing device, e.g., thread blocks, warps, or subwarps.

In some such implementations, the system can assign tiles of the output matrix to thread blocks such that each of the thread blocks receives approximately the same amount of work to do. Further, the system can assign work to threads within the thread blocks such that each thread receives approximately the same amount of work to do.

For example, the system can sort the tiles of the output matrix based on the amount of computation required to determine values for the tiles. As a particular example, the system can sort the tiles based on the number of non-zero values in the row of the sparse matrix corresponding to each tile. This approximates the amount of work required to execute a given tile, because the amount of work required to compute values for a tile increases with the number of non-zero elements in the row of the sparse matrix that corresponds to the tile.

In some implementations, after ordering the tiles based on the amount of computations required to execute them, the system can assign tiles to thread blocks in a “snake” pattern. That is, if there are Q thread blocks, numbered 1 through Q, in the parallel processing device, then the system can assign the Q most computationally-heavy tiles to the Q thread blocks in order. Then, the system can assign the next Q most computationally-heavy tiles to the thread blocks in reverse order. Thus, the 1^{st} thread block receives the 1^{st} and (2Q)^{th} most computationally-heavy tiles, while the Q^{th} streaming multiprocessor receives the Q^{th} and (Q+1)^{th} most computationally-heavy tiles. The system can continue to assign the next Q most computationally-heavy tiles in this way until all tiles have been assigned. Thus, work can be balanced across the different thread blocks, such that a single thread block is not assigned multiple of the most computationally-expensive tiles.

In some other implementations, after ordering the tiles based on the amount of computations required to execute them, the system can group the tiles into groups of similar computational cost. That is, tiles that require a similar amount of computations to execute can be placed in the same group. The system can then assign each group of tiles to a respective thread block. In other words, for each thread block of the parallel processing device, each tile that the thread block processes requires approximately the same amount of work. Furthermore, for each thread block, the computational cost of computing the value for each element of each thread block is approximately the same, because each value is the inner product between a row of the sparse matrix (which have been grouped into similar sizes) and a column of the second matrix. Thus, work can be balanced across threads of a single thread block, such that a first subset of threads in a thread block are not assigned significantly more work than a second subset of threads, causing the second subset of threads to be inactive (or to be performing worthless operations) while the first subset of threads completes their operations.

Referring to the example depicted in FIG. 3C, under a first policy 330 for assigning tiles to thread blocks, the system can assign tiles sequentially. In particular, the system can assign each tile corresponding to the 0^{th} and 1^{st} rows of the sparse matrix to a first thread block, each tile corresponding to the 2^{nd} and 3^{rd} rows of the sparse matrix to a second thread block, and so on. However, this can cause an imbalance of work within the thread blocks. For example, within the first thread block, a first subset of threads compute values of the output matrix corresponding to the 0^{th} row while a second subset of threads compute values of the output matrix corresponding to the 1^{st} row; thus, the first subset of threads must perform more operations, during which time the second subset of threads cannot do useful work.

Under a second policy 340, the system groups the tiles corresponding to similarly-sized rows of the sparse matrix and assigns each group of tiles to a respective thread block. In particular, the system assigns each tile corresponding to the 0^{th} and 5^{th} rows of the sparse matrix to a first thread block, each tile corresponding to the 1^{st} and 3^{rd} rows of the sparse matrix to a second thread block, each tile corresponding to the 4^{th} and 7^{th} rows of the sparse matrix to a third thread block, and each tile corresponding to the 2^{nd} and 6^{th} rows of the sparse matrix to a fourth thread block. In this way, for each thread block, the system can balance the work done by threads within the thread block. For example, within the first thread block, each thread computes values of the output matrix corresponding to 0^{th} or the 5^{th} row of the sparse matrix, which have the same size.

Although under the second policy 230, work may not be perfectly balanced across the different thread blocks (i.e., the first thread block processes tiles corresponding to larger rows of the sparse matrix than the second thread block), when performing matrix multiplications with many rows (e.g., hundreds, thousands, or tens of thousands of rows), this imbalance can be minimal because each thread block is assigned multiple different groups of tiles. For example, the system can assign new groups of tiles to thread blocks on-demand as the thread blocks finish processing their originally-assigned groups. As another example, the system can assign groups of tiles in a snake pattern, as described above.

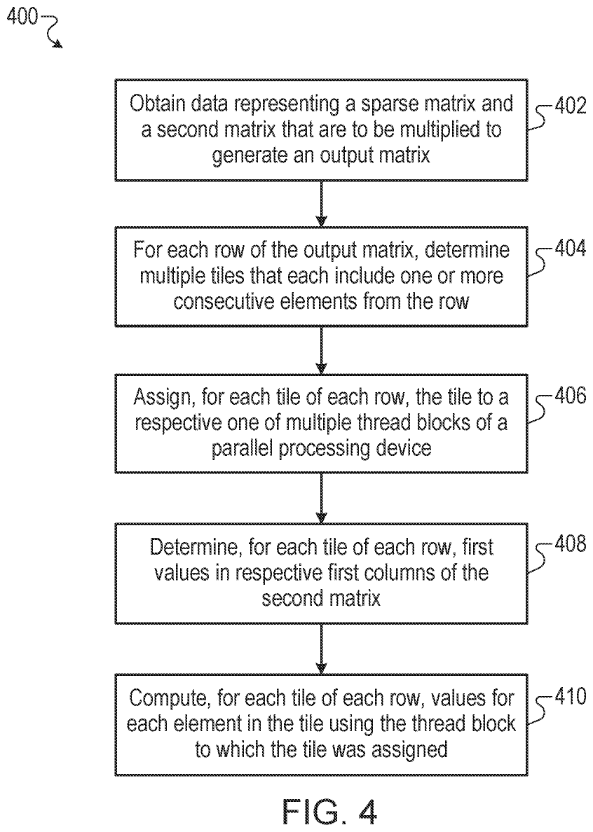

FIG. 4 is a flowchart of an example process 400 for parallelizing computations of a matrix multiplication. The process 400 can be implemented by one or more computer programs installed on one or more computers and programmed in accordance with this specification. For example, the process 400 can be performed by a parallel processing device, e.g., the parallel processing device 100 depicted in FIG. 1A. For convenience, the process 400 will be described as being performed by a system of one or more computers.

The system obtains data representing a sparse matrix and a second matrix that are to be multiplied to generate an output matrix (step 402). The sparse matrix has size M×K, the second matrix has size K×N, and the output matrix has size M×N.

The system determines, for each row of the M rows of the output matrix, multiple tiles that each include one or more consecutive elements form the row (step 404).

The system assigns, for each tile of each row, the tile to a respective one of multiple thread blocks of a parallel processing device (step 406). Each thread block can include multiple of warps, and each warp of each thread block can include multiple of threads.

The system determines, for each tile of each row r of the M rows of the output matrix, multiple first values in respective first columns of the second matrix (step 408).

For example, for each tile of each row r in the output matrix, the system can do the following. For each element in the tile, the system can identify the position i of the element in the row r of the output matrix, and identify the corresponding column i in the second matrix. These identified columns in the second matrix can be called “first columns” of the second matrix. Then, for each non-zero element in the row r of the sparse matrix, the system can identify a position j of the non-zero element in the row r of the sparse matrix, and identify the corresponding value in each first column of the second matrix that is in position j of the first column. These identified values in a first column of the second matrix are those values that will be multiplied by the non-zero elements of the sparse matrix to compute the value of a respective element of the tile in the output matrix. In this specification, these values will be called “first values” of the first column of the second matrix.

In this way, the system can identify the first values of each of the first columns of the second matrix for a particular tile in row r of the output matrix. Then, for each first column i (corresponding to element i in the tile), the system can provide the first values for the first column to a respective thread in a respective warp of the thread block to which the tile has been assigned. The system can also provide the non-zero elements of the row r of the sparse matrix to the thread.

The system computes, for each tile of each row r of the M rows of the output matrix, values for each element in the tile using the thread block to which the tile was assigned (step 410).

For example, the system can compute the value of the element i of the tile by multiplying i) a vector composed of the first values in the first column i, and ii) a vector composed of the non-zero elements of row r of the sparse matrix. A warp can execute these operations for multiple such elements in the tile in parallel, while the thread block to which the tile has been assigned can control the operations of all of its warps to compute the values for every element in the tile.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method of parallelizing, on a parallel processing hardware device, a matrix multiplication between a sparse matrix and a second matrix to generate an output matrix, wherein the sparse matrix has size M×K, the second matrix has size K×N, and the output matrix has size M×N, the method comprising:

for each row of the M rows of the output matrix, determining a plurality of tiles that each include one or more elements from the row;

assigning, for each tile of each row, the tile to a respective one of a plurality of thread blocks of the parallel processing hardware device, wherein each thread block comprises a plurality of warps and each warp of each thread block comprises a plurality of threads;

determining, for each particular tile of each row r of the M rows of the output matrix, a plurality of first values in a plurality of first columns in the second matrix, comprising:
for each element in the particular tile:
   identifying a position i of the element in the row r of the output matrix, and
   identifying a first column that is the ith column of the second matrix; and
for each non-zero element in the particular row in the sparse matrix:
   identifying a position j of the non-zero element in the row r of the sparse matrix, and
   identifying a first value in each first column of the second matrix that is in position j in the first column; and

computing, for each particular tile of each particular row r of the M rows of the output matrix, respective values for each element in the particular tile using the respective thread block to which the particular tile was assigned, comprising:
multiplying, for each first column in the second matrix, i) a vector of the first values in the first column and ii) a vector of the non-zero elements of the particular row r in the sparse matrix, using a particular thread of a particular warp of the respective thread block to which the particular tile was assigned.

Embodiment 2 is the method of embodiment 1, wherein each tile of a row is assigned to a different respective one of the plurality of thread blocks.

Embodiment 3 is the method of embodiment 1, wherein assigning, for each tile of each row, the tile to a respective one of a plurality of thread blocks of the parallel processing hardware device comprises:

assigning a plurality of tiles to a particular thread block,

assigning, for each tile of the plurality of tiles assigned to the particular thread block, the tile to a respective one of a plurality of subwarps of a respective one of the warps of the particular thread block.

Embodiment 4 is the method of any one of embodiments 1-3, wherein the sparse matrix is in a compressed sparse row (CSR) format.

Embodiment 5 is the method of embodiment 4, wherein computing, for each particular tile of each particular row r of the M rows of the output matrix, respective values for each element in the particular tile using the respective thread block to which the particular tile was assigned comprises:

loading a row offset of the particular row r in the sparse matrix;

calculating a row length of the particular row r in the sparse matrix; and

decrementing the row offset to an address that is aligned with a vector width of the parallel processing hardware device, wherein

multiplying, for each first column in the second matrix, i) a vector of the first values in the first column and ii) a vector of the non-zero elements of the particular row r in the sparse matrix, using a particular thread of a particular warp of the respective thread block to which the particular tile was assigned comprises:

masking non-zero elements from a previous row that is before the particular row r in the sparse matrix.

Embodiment 6 is the method of any one of embodiments 1-5, wherein:

each thread block is processed by a respective streaming multiprocessor of a plurality of streaming multiprocessors of the parallel processing hardware device; and

assigning, for each tile of each row, the tile to a respective one of a plurality of thread blocks of the parallel processing hardware device comprises:

assigning the tiles so that each streaming multiprocessor of the plurality of streaming multiprocessors of the parallel processing hardware device processes approximately a same number of non-zero elements of the sparse matrix.

Embodiment 7 is the method of embodiment 6, wherein:

assigning the tiles so that each streaming multiprocessor of the plurality of streaming multiprocessors of the parallel processing hardware device processes approximately a same number of non-zero elements of the sparse matrix comprises:

sorting the thread blocks according to the number of non-zero elements of the sparse matrix that must be processed in order to execute a respective thread block; and

assigning each thread block to a respective one of the streaming multiprocessors in a snake pattern.

Embodiment 8 is the method of any one of embodiments 1-7, wherein the sparse matrix is a weight matrix of a neural network layer of a neural network, the second matrix is a dense activation matrix of the neural network layer, and the output matrix is an output of the neural network layer

Embodiment 9 is the method of any one of embodiments 1-7, wherein the sparse matrix is a transpose of a weight matrix of a neural network layer of a neural network, the second matrix is a dense backpropagated gradient matrix of the neural network, and the output matrix is a gradient matrix of the neural network layer.

Embodiment 10 is a method of implementing a neural network on a parallel processing device, the neural network comprising a plurality of layers including at least one sparse neural network layer,

the sparse neural network layer being configured to receive an input matrix and perform matrix multiplication between the input matrix and a sparse weight matrix to generate an output matrix, wherein the sparse weight matrix has size M×K, the input matrix has size K×N, and the output matrix has size M×N, the method comprising:

for each row of the M rows of the output matrix, determining a plurality of tiles that each include one or more elements from the row;

assigning, for each tile of each row, the tile to a respective one of a plurality of thread blocks of the parallel processing device, wherein each thread block comprises a plurality of warps and each warp of each thread block comprises a plurality of threads;

determining, for each particular tile of each row r of the M rows of the output matrix, a plurality of first values in a plurality of first columns in the input matrix, comprising:
for each element in the particular tile:
   identifying a position i of the element in the row r of the output matrix, and
   identifying a first column that is the ith column of the input matrix; and
for each non-zero element in the particular row in the sparse weight matrix:
   identifying a position j of the non-zero element in the row r of the sparse weight matrix, and
   identifying a first value in each first column of the input matrix that is in position j in the first column; and

computing, for each particular tile of each particular row r of the M rows of the output matrix, respective values for each element in the particular tile using the respective thread block to which the particular tile was assigned, comprising:
multiplying, for each first column in the input matrix, i) a vector of the first values in the first column and ii) a vector of the non-zero elements of the particular row r in the sparse weight matrix, using a particular thread of a particular warp of the respective thread block to which the particular tile was assigned.

Embodiment 11 is the method of embodiment 10, wherein each tile of a row is assigned to a different respective one of the plurality of thread blocks.

Embodiment 12 is the method of any one of embodiments 10 or 11, wherein assigning, for each tile of each row, the tile to a respective one of a plurality of thread blocks of the parallel processing hardware device comprises:

assigning a plurality of tiles to a particular thread block,

assigning, for each tile of the plurality of tiles assigned to the particular thread block, the tile to a respective one of a plurality of subwarps of a respective one of the warps of the particular thread block.

Embodiment 13 is the method of any one of embodiments 10-12, wherein the sparse weight matrix is in a compressed sparse row (CSR) format.

Embodiment 14 is the method of embodiment 13, wherein computing, for each particular tile of each particular row r of the M rows of the output matrix, respective values for each element in the particular tile using the respective thread block to which the particular tile was assigned comprises:

loading a row offset of the particular row r in the sparse weight matrix;

calculating a row length of the particular row r in the sparse weight matrix; and

decrementing the row offset to an address that is aligned with a vector width of the parallel processing hardware device, wherein

multiplying, for each first column in the input matrix, i) a vector of the first values in the first column and ii) a vector of the non-zero elements of the particular row r in the sparse weight matrix, using a particular thread of a particular warp of the respective thread block to which the particular tile was assigned comprises:

masking non-zero elements from a previous row that is before the particular row r in the sparse weight matrix.

Embodiment 15 is the method of any one of embodiments 10-14, wherein:

each thread block is processed by a respective streaming multiprocessor of a plurality of streaming multiprocessors of the parallel processing hardware device; and

assigning, for each tile of each row, the tile to a respective one of a plurality of thread blocks of the parallel processing hardware device comprises:

assigning the tiles so that each streaming multiprocessor of the plurality of streaming multiprocessors of the parallel processing hardware device processes approximately a same number of non-zero elements of the sparse weight matrix.

Embodiment 16 is the method of embodiment 15, wherein:

assigning the tiles so that each streaming multiprocessor of the plurality of streaming multiprocessors of the parallel processing hardware device processes approximately a same number of non-zero elements of the sparse weight matrix comprises:

sorting the thread blocks according to the number of non-zero elements of the sparse weight matrix that must be processed in order to execute a respective thread block; and

assigning each thread block to a respective one of the streaming multiprocessors in a snake pattern.

Embodiment 17 is a system comprising one or more computers and one or more storage devices storing instructions that when executed by the one or more computers cause the one more computers to perform the operations of the respective method of any one of embodiments 1-16.

Embodiment 18 is one or more non-transitory computer storage media storing instructions that when executed by one or more computers cause the one more computers to perform the operations of the respective method of any one of embodiments 1-16.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method of causing a parallel processing device to parallelize a matrix multiplication between a sparse matrix and a second matrix to generate an output matrix, wherein the sparse matrix has size M×K, the second matrix has size K×N, and the output matrix has size M×N, the method comprising:
for each row of the M rows of the output matrix, determining a plurality of tiles that each includes one or more elements from the row;
assigning, for each tile of each row, the tile to a respective one of a plurality of thread blocks of the parallel processing hardware device, wherein each thread block comprises a plurality of warps and each warp of each thread block comprises a plurality of threads;
determining, for each particular tile of each row r of the M rows of the output matrix, a plurality of first values in a plurality of first columns in the second matrix, comprising:
for each element in the particular tile:
identifying a position i of the element in the row r of the output matrix, and
identifying a first column that is the ith column of the second matrix; and
for each non-zero element in the row r of the sparse matrix:
identifying a position j of the non-zero element in the row r of the sparse matrix, and
identifying a first value in each first column of the second matrix that is in position j in the first column; and
causing the parallel processing device to compute, for each particular tile of each row r of the M rows of the output matrix, respective values for each element in the particular tile using the thread block to which the particular tile was assigned, the computing comprising:
multiplying, for each first column corresponding to the particular tile, i) a vector of the first values in the first column and ii) a vector of the non-zero elements of the row r in the sparse matrix, using a particular thread of a particular warp of the respective thread block to which the particular tile was assigned.

2. The method of claim 1, wherein each tile of a row is assigned to a different thread block of the plurality of thread blocks.

3. The method of claim 1, wherein assigning, for each tile of each row, the tile to a respective one of a plurality of thread blocks of the parallel processing hardware device comprises:
assigning a plurality of tiles to a particular thread block,
assigning, for each tile of the plurality of tiles assigned to the particular thread block, the tile to a respective one of a plurality of subwarps of a respective one of the warps of the particular thread block.

4. The method of claim 1, wherein the sparse matrix is in a compressed sparse row (CSR) format.

5. The method of claim 4, wherein computing, for each particular tile of each particular row r of the M rows of the output matrix, respective values for each element in the particular tile using the respective thread block to which the particular tile was assigned comprises:
loading a row offset of the particular row r in the sparse matrix;
calculating a row length of the particular row r in the sparse matrix; and
decrementing the row offset to an address that is aligned with a vector width of the parallel processing hardware device, wherein
multiplying, for each first column corresponding to the particular tile, i) a vector of the first values in the first column and ii) a vector of the non-zero elements of the particular row r in the sparse matrix, using a particular thread of a particular warp of the respective thread block to which the particular tile was assigned comprises:
masking non-zero elements from a previous row that is before the particular row r in the sparse matrix.

6. The method of claim 3, wherein:
each thread block is processed by a respective streaming multiprocessor of a plurality of streaming multiprocessors of the parallel processing hardware device; and
assigning, for each tile of each row, the tile to a respective one of a plurality of thread blocks of the parallel processing hardware device comprises:
assigning the tiles so that each streaming multiprocessor of the plurality of streaming multiprocessors of the parallel processing hardware device processes approximately a same number of non-zero elements of the sparse matrix.

7. The method of claim 6, wherein assigning the tiles so that each streaming multiprocessor of the plurality of streaming multiprocessors of the parallel processing hardware device processes approximately a same number of non-zero elements of the sparse matrix comprises:
sorting the tiles according to the number of non-zero elements of the row of the sparse matrix corresponding to the tiles; and
assigning each tile to a respective thread block in a snake pattern.

8. The method of claim 1, wherein:
assigning, for each tile of each row, the tile to a respective one of a plurality of thread blocks of the parallel processing hardware device comprises:
approximating, for each tile, an amount of work required to compute values for the tile;
generating a plurality of groups of tiles according to the approximated amounts of work; and
assigning, for each group of tiles, each tile in the group to the same thread block.

9. The method of claim 1, further comprising:
causing the parallel processing device to obtain values for a plurality non-zero elements in each of a plurality of rows of the sparse matrix using a single vector memory instruction.

10. The method of claim 1, wherein the sparse matrix is a weight matrix of a neural network layer of a neural network, the second matrix is a dense activation matrix of the neural network layer, and the output matrix is an output activation matrix of the neural network layer.

11. The method of claim 1, wherein the sparse matrix is an input activation matrix of a neural network layer of a neural network, the second matrix is a weight matrix of the neural network layer, and the output matrix is an output activation matrix of the neural network layer.

12. The method of claim 1, wherein the sparse matrix is a transposed weight matrix of a neural network layer of a neural network, the second matrix is a gradient of a dense output activation matrix of the neural network layer, and the output matrix is a gradient of an input activation matrix of the neural network layer.

13. The method of claim 1, wherein the sparse matrix is a gradient of an output activation matrix of a neural network layer of a neural network, the second matrix is a transposed weight matrix of the neural network layer, and the output matrix is a gradient of an input activation matrix of the neural network layer.

14. A method of causing a parallel processing device to implement a neural network, the neural network comprising a plurality of layers including at least one sparse neural network layer,
the sparse neural network layer being configured to receive an input matrix and perform matrix multiplication between the input matrix and a sparse weight matrix to generate an output matrix, wherein the sparse weight matrix has size M×K, the input matrix has size K×N, and the output matrix has size M×N, the method comprising:
for each row of the M rows of the output matrix, determining a plurality of tiles that each include one or more elements from the row;
assigning, for each tile of each row, the tile to a respective one of a plurality of thread blocks of the parallel processing device, wherein each thread block comprises a plurality of warps and each warp of each thread block comprises a plurality of threads;
determining, for each particular tile of each row r of the M rows of the output matrix, a plurality of first values in a plurality of first columns in the input matrix, comprising:
for each element in the particular tile:
identifying a position i of the element in the row r of the output matrix, and
identifying a first column that is the ith column of the input matrix; and
for each non-zero element in the particular row in the sparse weight matrix:
identifying a position j of the non-zero element in the row r of the sparse weight matrix, and
identifying a first value in each first column of the input matrix that is in position j in the first column; and
causing the parallel processing device to compute, for each particular tile of each particular row r of the M rows of the output matrix, respective values for each element in the particular tile using the respective thread block to which the particular tile was assigned, the computing comprising:
multiplying, for each first column corresponding to the particular tile, i) a vector of the first values in the first column and ii) a vector of the non-zero elements of the particular row r in the sparse weight matrix, using a particular thread of a particular warp of the respective thread block to which the particular tile was assigned.

15. The method of claim 14, wherein each tile of a row is assigned to a different respective one of the plurality of thread blocks.

16. The method of claim 14, wherein assigning, for each tile of each row, the tile to a respective one of a plurality of thread blocks of the parallel processing hardware device comprises:
assigning a plurality of tiles to a particular thread block,
assigning, for each tile of the plurality of tiles assigned to the particular thread block, the tile to a respective one of a plurality of subwarps of a respective one of the warps of the particular thread block.

17. The method of claim 14, wherein the sparse weight matrix is in a compressed sparse row (CSR) format.

18. The method of claim 17, wherein computing, for each particular tile of each particular row r of the M rows of the output matrix, respective values for each element in the particular tile using the respective thread block to which the particular tile was assigned comprises:
loading a row offset of the particular row r in the sparse weight matrix;
calculating a row length of the particular row r in the sparse weight matrix; and
decrementing the row offset to an address that is aligned with a vector width of the parallel processing hardware device, wherein
multiplying, for each first column corresponding to the particular tile, i) a vector of the first values in the first column and ii) a vector of the non-zero elements of the particular row r in the sparse weight matrix, using a particular thread of a particular warp of the respective thread block to which the particular tile was assigned comprises:
masking non-zero elements from a previous row that is before the particular row r in the sparse weight matrix.

19. The method of claim 14, wherein:
each thread block is processed by a respective streaming multiprocessor of a plurality of streaming multiprocessors of the parallel processing hardware device; and
assigning, for each tile of each row, the tile to a respective one of a plurality of thread blocks of the parallel processing hardware device comprises:
assigning the tiles so that each streaming multiprocessor of the plurality of streaming multiprocessors of the parallel processing hardware device processes approximately a same number of non-zero elements of the sparse weight matrix.

20. The method of claim 19, wherein assigning the tiles so that each streaming multiprocessor of the plurality of streaming multiprocessors of the parallel processing hardware device processes approximately a same number of non-zero elements of the sparse matrix comprises:
sorting the tiles according to the number of non-zero elements of the row of the sparse matrix corresponding to the tiles; and
assigning each tile to a respective thread block in a snake pattern.

21. The method of claim 14, wherein:
assigning, for each tile of each row, the tile to a respective one of a plurality of thread blocks of the parallel processing hardware device comprises:
approximating, for each tile, an amount of work required to compute values for the tile;
generating a plurality of groups of tiles according to the approximated amounts of work; and
assigning, for each group of tiles, each tile in the group to the same thread block.

22. The method of claim 14, further comprising:
causing the parallel processing device to obtain values for a plurality non-zero elements in each of a plurality of rows of the sparse matrix using a single vector memory instruction.

23. A method of causing a parallel processing device to parallelize a sampled dense-dense matrix multiplication between a first dense matrix, a second dense matrix, and an sparse input matrix to generate a sparse output matrix, wherein the first dense matrix size M×K, the second dense matrix has size K×N, the sparse input matrix has size M×N, and the sprase output matrix has size M×N, the method comprising:
for each row of the M rows of the sparse output matrix:
determining, using the sparse input matrix, a plurality of non-zero elements of the row of the sparse output matrix; and
determining a plurality of tiles that each includes one or more non-zero elements from the row of the sparse output matrix;
assigning, for each tile of each row, the tile to a respective one of a plurality of thread blocks of the parallel processing hardware device, wherein each thread block comprises a plurality of threads;
determining, for each particular tile of each row r of the M rows of the sparse output matrix, a plurality of first columns in the second dense matrix, comprising, for each element in the particular tile:
identifying a position i of the element in the row r of the sparse output matrix, and
identifying a first column that is the ith column of the second dense matrix; and
causing the parallel processing device to compute, for each particular tile of each row r of the M rows of the sparse output matrix, respective values for each element in the particular tile using the thread block to which the particular tile was assigned, the computing comprising:
multiplying, for each first column corresponding to the particular tile, i) the first column and ii) the row r in the first dense matrix, using one or more threads of the respective thread block to which the particular tile was assigned.

24. The method of claim 23, wherein each tile of a row is assigned to a different thread block of the plurality of thread blocks.

25. The method of claim 23, wherein assigning, for each tile of each row, the tile to a respective one of a plurality of thread blocks of the parallel processing hardware device comprises:
assigning a plurality of tiles to a particular thread block,
assigning, for each tile of the plurality of tiles assigned to the particular thread block, the tile to a respective one of a plurality of subwarps of the particular thread block.

26. The method of claim 23, wherein the first dense matrix is a gradient of an output activation matrix of a neural network layer of a neural network, the second dense matrix is a transposed input activation matrix of the neural network layer, the sparse input matrix is an identify of a weight matrix of the neural network layer, and the sparse output matrix is gradient of the weight matrix.

27. The method of claim 23, wherein the first dense matrix is a transposed weight matrix of a neural network layer of a neural network, the second dense matrix is a gradient of an output activation matrix of the neural network layer, the sparse input matrix is an identify of an input activation matrix of the neural network layer, and the sparse output matrix is a gradient of the input activation matrix.

28. (canceled)

29. (canceled)
